(19) United States
(12) Patent Application Publication
(10) Pub. No.: US 2022/0279448 A1
(43) Pub. Date: Sep. 1, 2022

(54) THERMAL MANAGEMENT BY SYSTEMATIC NETWORK RECONFIGURATION

(71) Applicants: Edwin IUN, Ottawa (CA); Puneet ARORA, Ottawa (CA)

(72) Inventors: Edwin IUN, Ottawa (CA); Puneet ARORA, Ottawa (CA)

(73) Assignee: TELEFONAKTIEBOLAGET LM ERICSSON (PUBL), Stockholm (SE)

(21) Appl. No.: 17/621,929

(22) PCT Filed: Jul. 30, 2019
(86) PCT No.: PCT/IB2019/056503

§ 371 Date: Dec. 22, 2021

(51) Int. Cl. H04W 52/02; H04W 52/38

(52) U.S. Cl. CPC H04W 52/0235; H04W 52/0206; H04W 52/386

(57) ABSTRACT

Methods and systems for thermal management of a telecommunications network having at least one wireless radio equipment system in communication with a plurality of radio heads. The wireless radio equipment system has a thermal management component. Each of the plurality of radio heads has a high operating temperature threshold. The methods and system configured to monitor the operating temperature of the plurality of radio heads by the thermal management component. If a determination by the thermal management component that at least one of the radio heads exceeds its high operating temperature threshold, a reconfiguring of the telecommunications network to reduce the operating temperature of the at least one of the plurality of radio heads.

### TECHNICAL FIELD

This disclosure relates to thermal management, and in particular to thermal management by systematic network reconfiguration.

### BACKGROUND

Many times, overheating within a network is considered a hardware issue and has to be addressed by hardware changes.

Radio equipment is equipped with temperature sensors. When the equipment reaches a maximum operating temperature, the equipment is considered to be under an over-temperature condition. Beyond this point, the equipment is not engineered to operate and a prolong use will damage the electronic components and the equipment life is shortened. Furthermore, there may be a fire hazard if the device is too hot. FIG. 1 illustrates the different thresholds in a normal thermal management.

In the prior art, there are two primary handling mechanisms. The first is transmitter power backoff which means the output power of the all of the affected radio equipment's power amplifiers are reduced. This is done when the equipment detects a high temperature condition. The goal is that a reduced output power would reduce the heat generation, and air circulation would bring the temperature down.

When the temperature continues to rise to the maximum operating temperature, the equipment would perform a shutdown. In that case, the heat contributing components are turned off completely for a predefined period of time. This is a self-protection approach with the goal of dropping the temperature to an acceptable level. The equipment would re-examine the temperature when the predefined time has passed.

The Fifth Generation (5G) network has a goal of high throughput using a wide bandwidth carrier. Wide bandwidth is rare in sub-3.5 GHz frequency but it is available in high frequency spectrum. With 5G operating at higher frequencies in mmWave these frequencies experience higher pathloss and is subject to line of sight limitation. It is destructive for the radio access point to be completely shutdown if it is overheating. The reason is that the RF signal from its neighboring Access Point may not be strong enough to overcome the high pathloss to reach and fill the coverage gap. This results in a service outage hole.

Additionally, the market trend is to reduce the size of radio equipment while being continuously compared against the coverage and performance offered by larger equipment. The promise of mmWave in 5G is that the antenna size can be much smaller due to shorter wavelength. However, it also promises high throughput which requires high radiating power. In 5G, this contradicting requirement of miniaturization vs. maximum output power is currently a technical barrier which leads to higher heat density in the small radio equipment form factor.

FIG. 2 illustrates an exemplary deployment of a service overlapping wireless system. A typical service overlapping wireless system includes a network core being in communication with two or more wireless radio equipment systems, e.g. 4G and 5G. Each of the wireless radio equipment systems are in communication with a plurality of radio heads. Depending on the type of system the radio heads may be local or remote.

Examples of an overlapping wireless system include a Distributed Antenna System (DAS) or Local Area Base Station Radio Dot System (RDS). In the deployment of such systems, each Remote Radio Head covers an assigned geographical area. However, due to the proximity, the UE would be able to receive the downlink (DL) signal from an adjacent remote radio head. This is the overlapping by the same cell and wireless radio equipment. At the same time, geographical area is usually covered by more than one cell. In the realm of 5G Non-Standalone (NSA) deployment, the 4G and 5G cells are collocated as designed. The same is true for an Indoor deployment where the outdoor Wide Area Range (macro) base station would have signal penetrated into the building. This is the inter-cell overlapping.

Other than the inter-cell overlapping, there is also the intra-cell overlapping. One of the key features of a DAS system or RDS is that the same RF information is repeated through all the remote radio heads. For example, the downlink transmission across A1, B1 and C1 is identical. When a UE receives signal from more than one remote radio heads, it is treated as multipath and receives as antenna diversity.

The power consumption of a remote radio head is typically made up of three parts: an overhead amount to maintain the operation of the equipment, a portion dedicated to the overhead channels and a part assigned to the on-demand traffic channels. FIG. 3 illustrates a power consumption profile of a 3G base station, however the same pattern can be observed in other wireless technologies. The power consumption is a function of the traffic loading such that a high traffic base station consumes the most power. If the traffic load can be reduced, the power consumption drops consequently.

FIG. 4 illustrates a Radio Dot System implementing a distributed MIMO technique. This technique is used to improve the indoor connectivity in many countries. By using two separate 2×2 MIMO RDS Remote Radio Head hardware, a 4×4 MIMO cell can be configured. The UE under the coverage of both RDS Remote Radio Head would enjoy a 4×4 MIMO performance.

The prior art focuses on hardware centric solutions, i.e. the affected hardware is a standalone device. This approach has the following shortcomings:

When the equipment reaches the maximum operating temperature, it is power off for a predefined period of time. The equipment remains power off and becomes service impacting. Only when this predefined period of time has expired, the equipment is reattempted to restore the service.

The current solution relies solely on cooling by air circulation when a high temperature is reached. It is a passive method and under the influence of the environment factors. When the environmental condition is not improved, the equipment will continue to cycle between powering on and powering off.

The prior art includes transmitter power backoff to protect the hardware and thermal shutdown. A radio equipment is treated as a standalone electronic equipment. There is no attempt to mitigate the cell coverage reduction since it is accepted as a consequence beyond its scope.

When a location is experiencing overheating condition and the air circulation method failed, the solution is to add an active cooling fan. This is not always feasible or possible in the location of installation.

### SUMMARY

In some aspects, a method is disclosed for the thermal management of a telecommunications network. The telecommunications network has at least one wireless radio equipment system in communication with a plurality of radio heads, which may be local, remote or a combination thereof. Each wireless radio equipment system has thermal management component. Each of the plurality of radio heads has a high operating temperature threshold.

In this aspect, the thermal management component monitors the operating temperature of the plurality of radio heads and determines if at least one of the radio heads exceeds its high operating temperature threshold. If such a determination is made, the thermal management component reconfigures the telecommunications network to reduce the operating temperature of the at least one of the plurality of radio heads.

In some of these aspects, the monitoring of the plurality of radio heads may include periodically polling by the thermal management component of each of the plurality of radio heads to report temperature, pushing of temperature report by each of the plurality of radio heads or a combination thereof.

In some of these aspects, the reconfiguring the telecommunications network may include the reducing power consumption by traffic shaping, which may include a handoff of an entire user equipment to the same or a different radio head of the plurality of radio heads; reducing power consumption by reducing the maximum throughput of those radio heads that exceed their high operating temperature threshold; reducing power to the at least one hot radio head of the plurality of radio heads and increasing power to the remainder of the plurality of radio heads; reducing power consumption by carrier relocation including moving a carrier from a first branch to a second branch and turning off the second branch; and/or reducing power consumption by reducing power across the entire bandwidth.

In some of these aspects, the reconfiguring the telecommunications network may include the puncturing of the telecommunications network to reduce heat generated by the radio head. In some of these aspects, the puncturing is defined as MIMO puncturing where the puncturing includes turning off at least one antenna branch of the telecommunications network, while in other aspects, the puncturing is defined as Carrier Aggregation (CA) puncturing where the puncturing includes turning off at least one filter branch of the telecommunications network.

In some of these aspects, the reconfiguring the telecommunications network may be performed for a predetermined amount of time and stopped upon the expiration of the predetermined amount of time or condition.

In some of these aspects, each of the plurality of radio heads has a normal operating temperature range that is less than its high operating temperature threshold and/or has a maximum operating temperature that is greater than, or approximately equal to, its high operating temperature threshold. In these aspects, the reconfiguring the telecommunications network may be performed until the operating temperature of the hot radio heads are reduced below its high operating temperature threshold and/or is within its normal operating temperature range.

Corresponding aspects include one or more systems configured to perform any of the operations set forth in the above aspects.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates an exemplary thermal profile and handling of over-temperature.

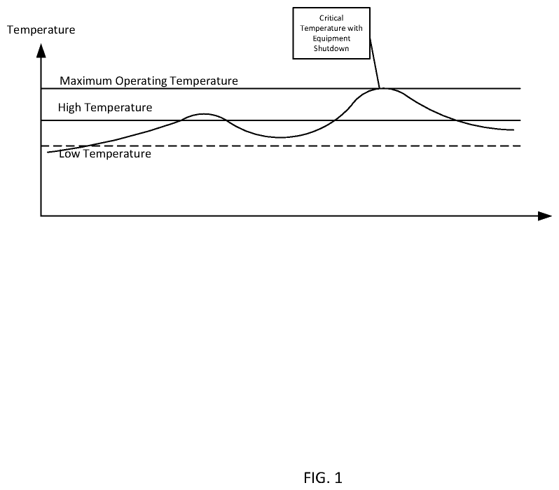

FIG. 2 illustrates a typical deployment of a service overlapping wireless system.

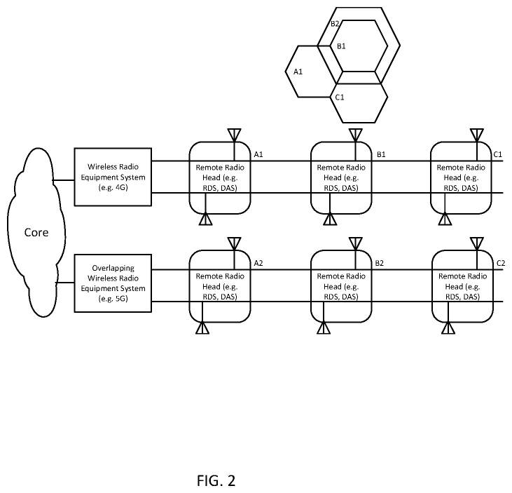

FIG. 3 illustrates a typical base station energy consumption as a function of traffic load diagram.

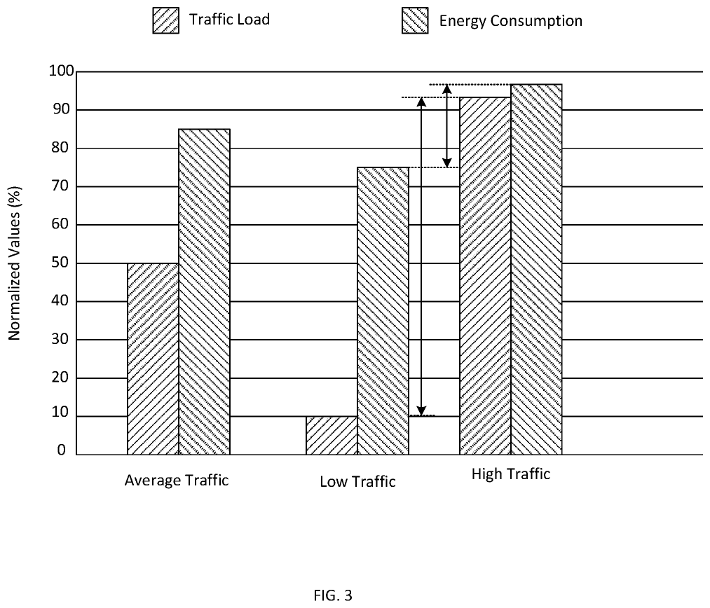

FIG. 4 illustrates an exemplary Radio Dot System implementing a distributed MIMO.

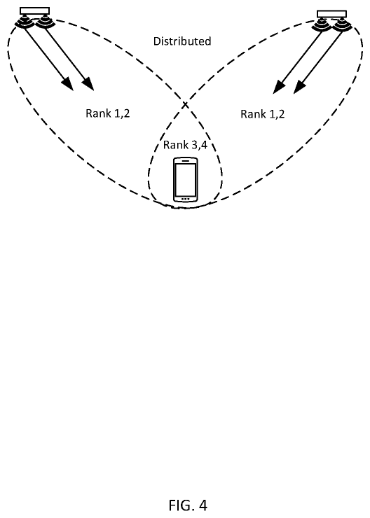

FIG. 5 illustrates an exemplary telecommunications network having a plurality of radio heads with one radio head experiencing near over-temperature.

FIG. 6 illustrates a flow diagram showing an embodiment of the thermal management of the present invention.

FIG. 7 illustrates a block diagram showing an embodiment the thermal management of the present invention.

FIG. 8 illustrates a block diagram showing an embodiment the thermal management utilizing MIMO puncturing.

FIG. 9 illustrates a block diagram showing an embodiment the thermal management utilizing transmitter power adjustment.

FIG. 10 illustrates a block diagram showing an embodiment the thermal management utilizing beam forming.

FIG. 11 illustrates a block diagram showing an embodiment the thermal management utilizing traffic rebalancing.

FIG. 12 illustrates a block diagram showing an embodiment the thermal management utilizing digital signal processing manipulation of carriers per branch.

FIG. 13 illustrates a block diagram showing an embodiment of digital signal processing manipulation.

FIG. 14 illustrates a block diagram showing an embodiment the thermal management of the present invention in a cloud environment.

### DETAILED DESCRIPTION

Before describing in detail exemplary embodiments, it is noted that the embodiments reside primarily in combinations of apparatus components and processing steps related to the thermal management by systematic network reconfiguration of a telecommunications network. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may inter-operate and modifications and variations are possible of achieving the electrical and data communication.

In some embodiments described herein, the term “coupled,” “connected,” and the like, may be used herein to indicate a connection, although not necessarily directly, and may include wired and/or wireless connections.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In general, methods and systems for the thermal management of a telecommunications network is disclosed. These methods and systems utilizes network reconfiguration to mitigate the overheating of network hardware by network signal puncturing and/or the manipulating of cell coverage, traffic shaping, maximum throughput, carrier setup and/or network planning.

The methods and systems for the thermal management of a telecommunications network by systematic network reconfiguration as disclosed herein provide various advantages over the prior art. One such advantage includes avoiding abrupt service interruption while allowing a gradual degradation with mitigation to avert being considered a service outage by regulatory. Further, there is no additional hardware cost by not requiring additional equipment such as cooling fan.

The methods and systems of the present invention resolving overheating gracefully in a 5G NR environment because it allows a gradual degradation by shutting off a portion of the antenna branches, reducing the radiating power or reducing the node capacity.

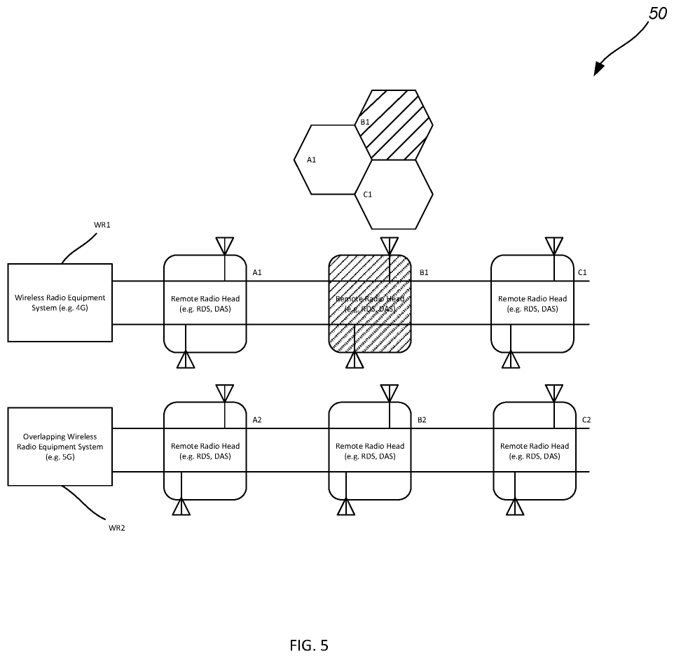

Referring now to the drawing figures, in which like elements are referred to by like reference numerals, there is shown in FIG. 5 illustrates an exemplary telecommunications network having a first wireless radio equipment system WR1, such as a 4G network, having a plurality of remote radio heads, otherwise known as power amplifiers, A1, B1 and C1, and having a second wireless radio equipment system WR2, such as a 5G network, having a plurality of remote radio heads A2, B2 and C2.

The inclusion of remote radio heads is illustrative. Those skilled in the art will recognize that local radio heads may be included and is within the scope of the present invention. Each radio head has a high operating temperature threshold and a maximum operating temperature. The maximum operating temperature is typically the highest temperature the radio head can operate before becoming damaged. In various embodiments, the high operating temperature for each radio head may be either less than or approximately equal to its maximum operating temperature. Further, each radio head may have a normal operating temperature range which is the temperature range in which the radio head regularly operates without risk of damage. The normal operating temperature range is less than its high operating temperature threshold.

In this embodiment, remote radio head B1 is shown to be exceeding its high operating temperature threshold. The methods and systems of the present invention continue the operation the remote radio head B1 when it reaches a high operating temperature threshold while the associated wireless radio equipment system performs thermal management procedures to cool the hot radio head B1.

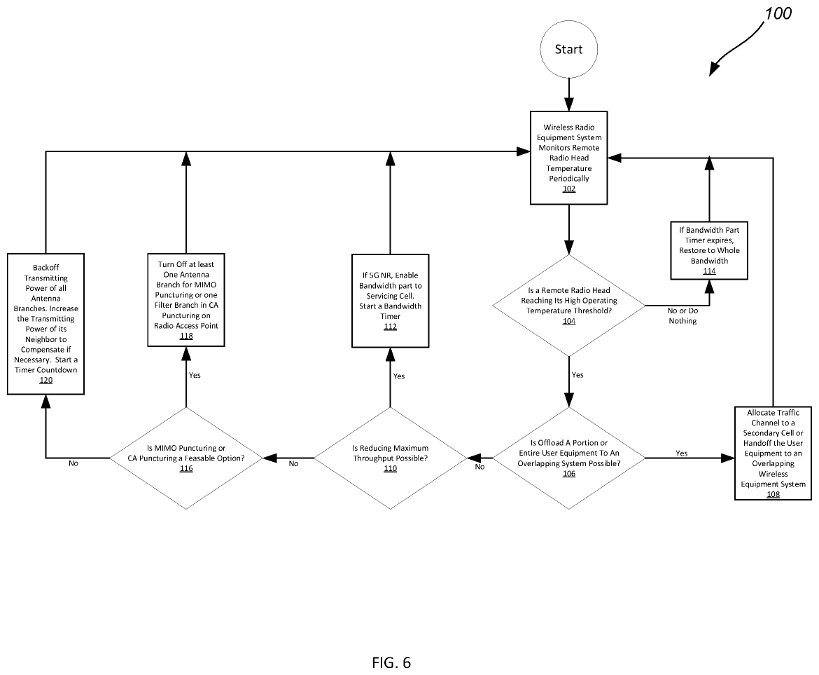

As shown in FIG. 6, a flow diagram showing the embodiment 100 of a method of the thermal management of the present invention is disclosed. The embodiment illustrates how various thermal management embodiments can be selected. The order of these embodiments is illustrative and can be interchanged.

In this embodiment, wireless radio equipment system WR1 monitors 102 the temperature of its remote radio heads A1, B1 and C1. The monitoring can be performed by pooling all the radio heads A1, B1 and C1 to report their temperature periodically and/or requesting the radio heads A1, B1 and C1 to report any significant events such as exceeding a high operating temperature threshold. Additionally, the monitoring may be performed by the radio heads pushing of temperature report to the wireless radio equipment system WR1.

The wireless radio equipment system WR1 determines 104 if a radio head has exceeded its high operating temperature threshold. If the determination results in a negative, or a no excessive temperature, conclusion, the method returns to the monitoring 102 of the system.

If, however, the determination results in a positive, or an excessive temperature, conclusion, the system may decide to proceed with the thermal management of the wireless network or to raise an alarm but take no further action.

If the system proceeds with using thermal management, the system may utilize one or more embodiments of thermal management. One embodiment occurs when there is overlapping radio area network (RAN) coverage availability 106. The system may offload a portion or the entire traffic channel, or to handoff the user equipment (UE) 108 to the overlapping RAN by traffic shaping. The offloading will allow the hot radio head handle a lighter traffic load, and as such consumes less power. This results in the hot radio head cooling down. After the cooling down, the method may return to the monitoring 102 of the system.

Another embodiment of the thermal management involves the query of whether the reduction of the maximum throughput or capacity temporary 110 is possible. If the serving radio technology is 5G NR supporting bandwidth part, the serving bandwidth is reduced dynamically 112 to reduce the base station power consumption. A timer may be started so that after a predefined period of time, the bandwidth is restored to normal operation 114. After the cooling down, the method may return to the monitoring 102 of the system.

Another embodiment of the thermal management involves the puncturing of the network. The system decides 116 if puncturing is a suitable option for this hot radio head. Considerations by the system can be deployment specific. For example, if the radio head is installed in the middle of a long corridor, puncturing may be an acceptable option due to the likelihood of signal leakage from a neighbor. On the other hand, if the installation is at the end of a hallway or if this is the only radio head on the floor, this may not be a suitable option.

In these embodiments, the puncturing may be MIMO puncturing or Carrier Aggregation (CA) puncturing. If MIMO puncturing or CA puncturing is the option chosen, at least one antenna branch of MIMO puncturing or at least one filter branch and therefore carrier in CA puncturing 118 of the hot radio head is turned off to reduce the heat generation by the hardware. When the hardware returns to an acceptable temperature, the antenna branch or filter branch is restored again to reinstate the full service. After the cooling down, the method may return to the monitoring 102 of the system.

Another embodiment involves a power backoff 120. If the system determines that antenna branch power backoff 120 is the option, the power backoff is applied to the hot radio head and this is a legacy prior-art behavior however this embodiment adds that the power to the neighboring radio heads is increased. In some of these embodiments, a timer may be used so that the overheat situation will be revisited after an engineered timeout period. Factors to considered are the traffic load of the neighboring radio heads, hardware limitation and thermal condition of the installation. After the cooling down, the method may return to the monitoring 102 of the system.

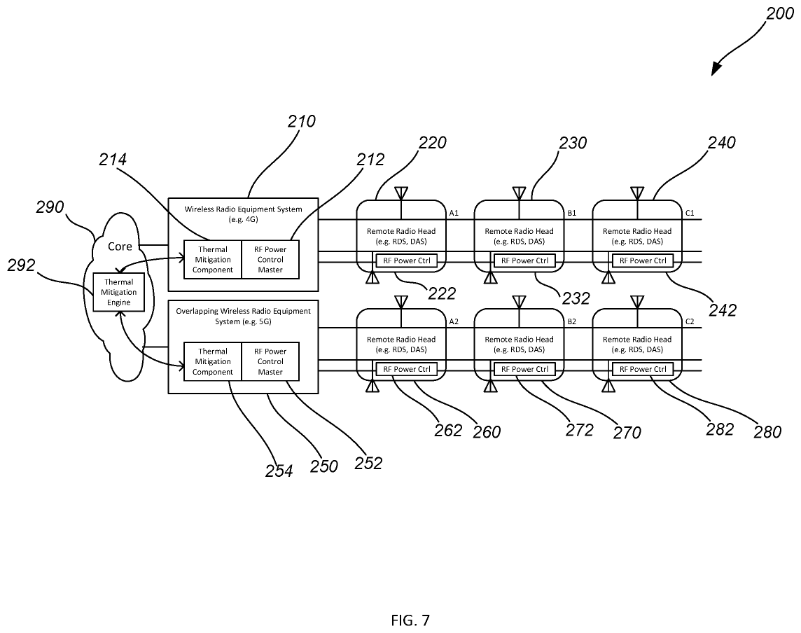

As shown in FIG. 7, a simplified block diagram of an embodiment of an exemplary telecommunications network system 200 of the present invention is shown. In this embodiment, the system includes a core network 290 having a first wireless radio equipment system 210, such as a 4G network, having a plurality of remote radio heads, 220, 230, 240, and having a second wireless radio equipment system 250, such as a 5G network, having a plurality of remote radio heads, 260, 270, 280.

Within each radio head is a RF power control component 222, 232, 242, 262, 272, 282 that is configured monitor and manage the RF power of the specific radio head. This control component may monitor the operating temperature of the specific radio head, provide temperature reports to the associated system, for example through a push or pull procedure, and act upon any thermal management instructions received from the associated system.

Within each wireless radio equipment system 210, 250, is a RF power control master component 212, 252 that is configured to control the RF power level of each remote radio head. Also within each wireless radio equipment system 210, 250, is a thermal mitigation component 214, 254 that is configured monitor the operating temperature of the associated radio head by reviewing the temperature reports received from each of the remote radio heads, for example through a push or pull procedure, to determine if thermal management is needed to cool a hot radio head, institute system-wide thermal management actions, and provide thermal management instructions to one or more of the associated remote radio heads.

Within the core network 290 is a thermal mitigation component 292. To be effective, the deployment of systematic network reconfiguration for thermal management needs to be collectively management across the entire telecommunications network. Accordingly, the thermal mitigation component 292 is configured to provide thermal management cooperation across both systems 210 and 250.

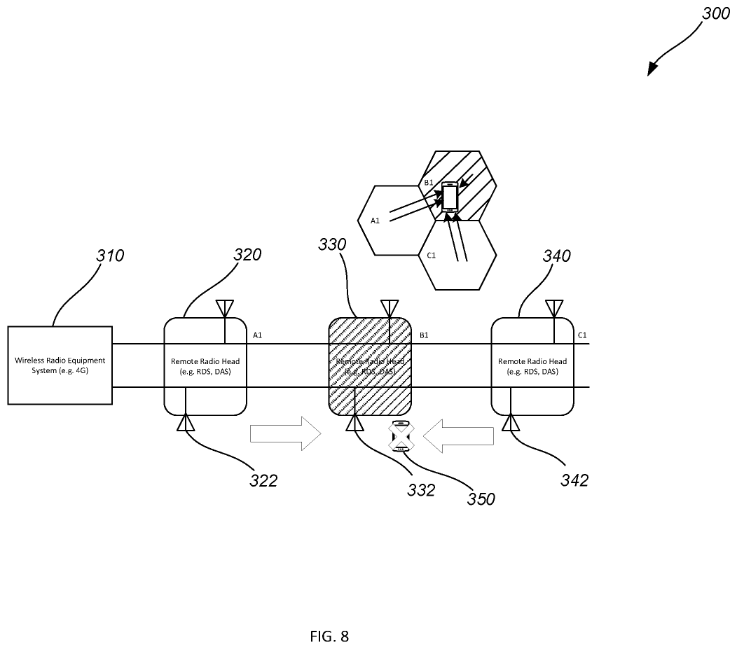

As shown in FIG. 8, an embodiment of the reconfiguring of the telecommunications network utilizing MIMO puncturing is disclosed. In this embodiment, an exemplary telecommunications network 300 having a first wireless radio equipment system 310, such as a 4G network, having a plurality of remote radio heads, 320, 330 and 340 where remote radio head 330 is shown to be exceeding its high operating temperature threshold.

As previously discussed, the distributed MIMO is used to achieve a higher rank without additional hardware. This is mainly for the coverage and performance reason.

This embodiment is applicable to MIMO where the cell is served by one radio head; also by distributed MIMO where the cell is served by more than one radio head. In this embodiment, the wireless radio equipment system 310 shuts down the antenna branch 332 that is associated with the hot radio head 330, and punctures the MIMO signal coverage thereto. The user equipment (UE) 350 may not receive equal signal strengths on all of its MIMO layer, however the UE connectivity can still be maintained while the hot radio head 330 has a chance to cool off before a total shut down. This gradual degradation is much preferable than B1 going out of service suddenly.

This embodiment utilizes spectral diversity and the fact that each layer of a MIMO system is interleaved to all RF branches of a radio front end. By turning off one RF branch of a Radio front end, at least one of the heat dissipating power amplifier will be turned off. This allows relieve of the thermal accumulation of the device so that it may not reach the maximum operating temperature and turn off. The UE 350 is able to receive all MIMO RF branches from the serving radio head 330 and its neighbor. The signal strength of one of its RF branches will be weaker and may incur a higher bit error rate, however the system is only degraded while the remote radio head 330 is attempting to cool off without shutting down.

When carriers are aggregated on the same dot or radio access point, the system can also redirect the traffic to one carrier, in which case the second carrier will be lightly used or not used at all. Since in a multicast system it may not be feasible to steer traffic to a single carrier for a single dot, in which case for the overheated dot it shall be possible to turn off the second carrier completely. The mechanism to control the carrier shall be implemented on a per Dot basis. With puncturing the carrier aggregation on the overheated dot we ensure that the other dots are still transmitting normally.

In other embodiments, CA puncturing may be employed. In such embodiments, CA puncturing shuts down some carriers inside RF branches to reduce power amplifier loading, whereas MIMO puncturing is to shut down an entire RF branch.

In other embodiments, the thermal management is implemented by techniques for manipulating cell coverage, traffic shaping, maximum throughput, carrier setup and network planning. Although each network reconfiguration technique will be described independently, they are not mutually exclusion and it is possible for a deployment to use a combination of these techniques.

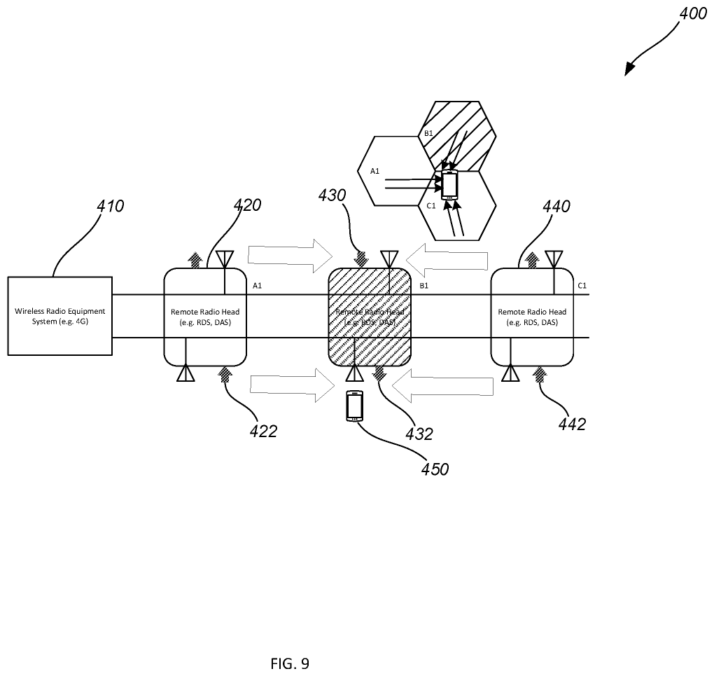

As shown in FIG. 9, an embodiment of the reconfiguring of the telecommunications network by proactively reducing power consumption entirely is disclosed. In this embodiment, an exemplary telecommunications network 400 having a first wireless radio equipment system 410, such as a 4G network, having a plurality of remote radio heads, 420, 430 and 440 where remote radio head 430 is shown to be exceeding its high operating temperature threshold.

In this embodiment, the transmitted power 432 to remote radio head 430 is gradually reduced. As shown in the cell coverage diagram, the coverage of 430 is shrunk by relieving the transmitters of all of its antenna branches from the higher power. The power generation is expected to drop and at the same time, the serving UE 450 may migrate to the neighboring remote radio heads 420 or 440. This gives hot remote radio head 430 a chance to cool off before reaching its maximum operating temperature.

At the same time, remote radio heads 420 and 440 can adjust to a higher transmit power 422, 442 when it becomes feasible to fill in the gap during this temporary measure. This is because remote radio heads 420 and 440 are transmitting the identical signal as remote radio head 430 in the form of space diversity. When remote radio head 430 reaches a safe temperature, the radio heads 420, 430 and 440 may be restore to their original operating configuration.

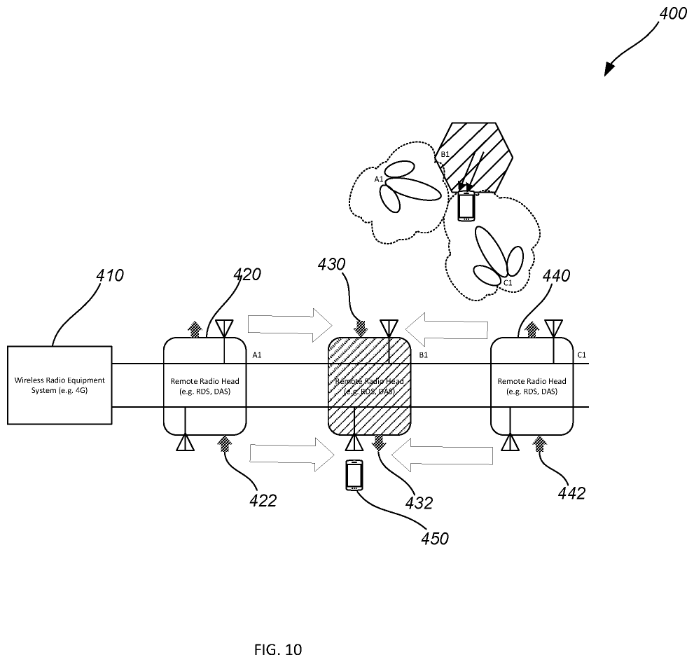

This embodiment assumes the remote radio heads 420, 430 and 440 have omnidirectional antenna, and therefore the cell coverages are uniform as shown in the sub-diagram. This is true today in DAS or RDS because an omnidirectional antenna with the same identical signal is broadcasted by all the Remote Radio Heads. When beamforming is becoming common to increase 4G capacity and 5G, a beamforming capability will become necessary on each remote radio head. Therefore, a non-uniform cell coverage by remote radio heads 420 and 440 with stronger signal towards remote radio head 430 to compensate for remote radio head 430 reduction is possible as shown in FIG. 10.

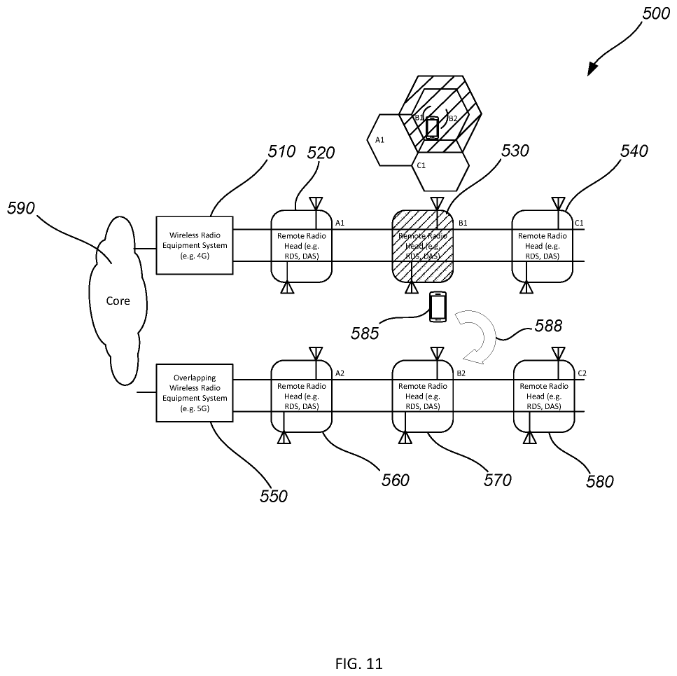

As shown in FIG. 11, an embodiment of the reconfiguring of the telecommunications network by implicitly reducing power consumption through traffic shaping is disclosed. In this embodiment, an exemplary telecommunications network 500 having includes a core network 590 having a first wireless radio equipment system 510, such as a 4G network, having a plurality of remote radio heads, 520, 530, 540, and having a second wireless radio equipment system 550, such as a 5G network, having a plurality of remote radio heads, 560, 570, 580, and where remote radio head 530 is shown to be exceeding its high operating temperature threshold.

In this embodiment the power consumption reduction is achieved by traffic shaping using a scheduler. FIG. 11 illustrates the situation of an overlapping RAN coverage. In the case of Non-Standalone (NSA) deployment of 5G, the UE 585 is served by the 4G RAN and 5G RAN simultaneously. The 4G RAN provides the overhead channels and traffic channels. When a high-speed data is required, the 4G RAN could instruct the UE to exchange data over the 5G RAN to manage its traffic load.

In this embodiment, the hot remote radio head 530 and its wireless radio equipment system 510 may decide to offload all data traffic 588 to the second wireless radio equipment system 550 while keeping the control plane intact. A reduced traffic may give enough relief to hot remote radio head 530 such that the rising temperature trend can be reversed. If the heated equipment is within a 5G network, e.g. remote radio head 570 instead of remote radio head 530 (not shown), the same technique can be used. Rather than allocating high speed traffic channel to the UE 585, this embodiment holds on to the 4G data traffic as onto remote radio head 530 much as possible. This allows remote radio head 570 to a lower traffic load, in the hope of keeping the device cooler.

Further, instead of the second wireless radio equipment system 550 being a 5G network, both second wireless radio equipment systems 510 and 550 are in LAA relationship where remote radio head 530 is the primary cell and remote radio head 570 is the secondary cell. This embodiment can be equally applicable to a carrier aggregation where the primary cell in remote radio head 530 can offload traffic to its secondary cell remote radio head 570. The offloading allows remote radio head 530 to have a lighter traffic load and therefore a lower power consumption and consequently a lower operating temperature.

In addition to the traffic offloading scenario, the UE 585 can be handoff to an overlapping 5G RAN. For example, in an indoor environment, the UE 585 is typically under the coverage of both indoor cell and outdoor macro cell. For performance reason, the indoor cell is preferred because 5G indoor typically has a stronger signal strength and therefore better throughput and coverage. 5G requires a higher signal-to-noise ratio and therefore Indoor close proximity is preferred. In a dire situation such as remote radio head 530 over-heating, the wireless radio equipment system 510 may decide to gracefully handoff UE 585 proactively to minimize system coverage interruption. The illustration of a 5G network is illustrative. The embodiment is also applicable to the current 4G overlapping indoor and outdoor deployment.

An additional embodiment of the reconfiguring of the telecommunications network by implicitly reducing power consumption through dynamic bandwidth is disclosed. As set out above, reducing power over the active transmitting bandwidth can result in a cooling of a hot radio head. The 5G NR bandwidth part feature allows the gNodeB and User Equipment (UE) to settle on using a portion of the total bandwidth. This transmitting bandwidth reduction and consequently the power reduction and cooling can also be achieved by an application of bandwidth part in 5G NR specification.

Most base stations can utilize the entire wider bandwidths available in 5G. User equipment (UE) capabilities, however, will vary and it will be very demanding for some UEs to mandate the use the entire available bandwidths all the time. UEs are not always exchanging in high data rate. The use of wide bandwidth may imply higher idling power consumption both from RF and baseband signal processing perspectives. Bandwidth part allows UE to operate on a sub-section of spectrum to reduce power, complexity and cost. It includes both uplink (UL) and downlink (DL). In other words, bandwidth part was originally designed for UE instead of base station.

This embodiment uses bandwidth part in a non-traditional purpose, reducing overheating. Since there is no signal needed outside the 5G NR bandwidth parts, the base station can reduce the total transmitted power and received power from the RF transmitter and receiver. When the radio reaches a high temperature threshold, instead of reducing the transmit power across the board on entire bandwidth, the base station can choose to reduce its bandwidth dynamically to reduce total power consumption. In other words, the base station trades the maximum capacity or throughput for cell coverage when comparing to the prior-art power back-off technique.

By reducing the bandwidth occupied bandwidth, the total power consumption may also be reduced. This is only applicable when the power spectral density remains constant. The bandwidth part activation and deactivation is controlled by a base station dynamically. When the overheating situation is no longer existed, the base station can restore to normal operation.

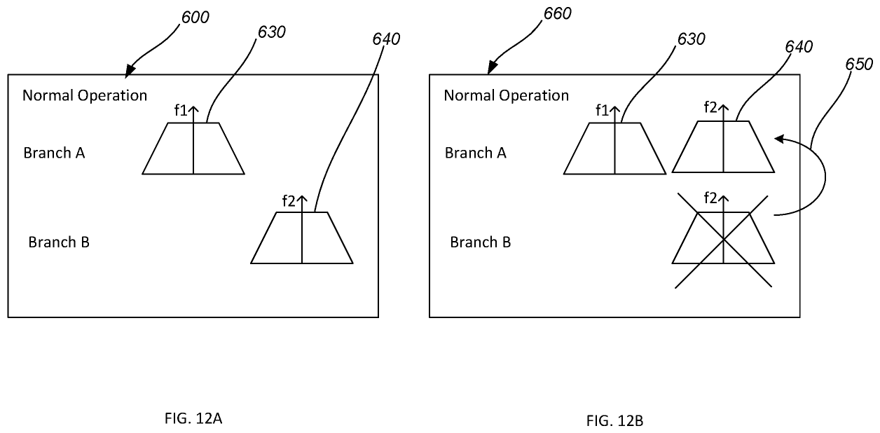

As shown in FIGS. 12A-12B, an embodiment of the reconfiguring of the telecommunications network by carrier relocation is disclosed. In a typically deployment of one Tx technology, such as WCDMA and GSM, during normal operations 600, a DL carrier 630, 640 is allocated to separate branches A and B to maximize resource utilization. In an overheated situation 660, it is possible to reduce power consumption by moving 650 the carrier 640 from branch B to branch A and reducing the output power to within to the maximum limit. This is using the fact that in an indoor environment of proximity, the DL signal has a margin which can be reduced without impacting the coverage. This allows the Branch B DL can be turned off completely to allow cooling.

In a Radio Dot System or a Distributed Antenna System, the carrier movement is controlled by the dot and shall only be done on the impacted dot that is overheating. Without informing the higher layer, the Dot or Radio Access Point can perform internal routing from Branch B into Branch A using digital or analog signal processing. It then can shut down Branch B to reduce the overall power consumption and achieve cooling relief.

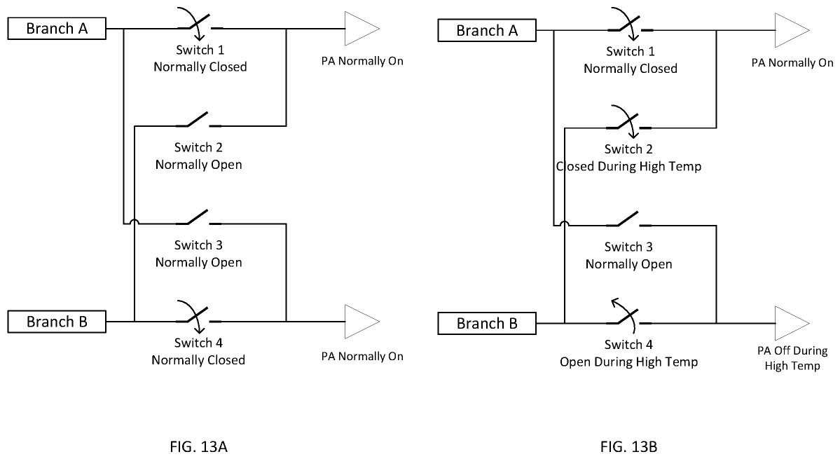

Referring to FIGS. 13A-13B, an embodiment of the digital signal processing manipulation for moving of a carrier from branch B to branch A. In this embodiment, during normal operations 700, carrier switches 2 and 3 are open to allow the carriers to be allocated to branches A and B, while carrier switches 1 and 4 are typically closed to prevent any cross over by the carriers into different branches. However, during an overheated situation, switch 2 is closed and switch 4 is open, allowing branch A to be closed.

An additional embodiment of the reconfiguring of the telecommunications network by proactive network planning In situations where the deployment environment is hot due to the climate or the location, a network administrator may need to plan for additional radio access point in anticipation of reaching maximum temperature and allowing head room reconfiguration as a consequence. In order to reduce coverage holes due to radio branches being turned off, it is possible that adjacent radios can increase their power to decrease coverage holes

5G NR supports different frequency ranges (FR): FR1 and FR2. The FR2 is higher frequency and is commonly referred as mmWave. The radio equipment is moving to multi-band support for real-estate reduction and an ease of deployment. In an NSA deployment, it is foreseen that 4G and 5G NR RAT be collocated inside the same radio equipment.

A high frequency mmWave deployment requires the radio access points to be closer together due to a high pathloss and line-of-sight limitation. This dense deployment is necessary for 5G NR deployment to work, however the 4G radio access point will be closer together due to co-siting. This unintended close proximity of 4G radio access point provides the head room that allowed power backoff without network coverage degradation.

In other words, the 4G RAT will take advantage of the dense deployment because of 5G NR mmWave introduction. This co-siting of NSA deployment opens the door of this new opportunity which was not available previously. With this close proximity, a transmit power reduction to a hot radio head may not require a transmit power boost from its neighboring radio heads because there is an inherit coverage redundancy in the 4G RAN.

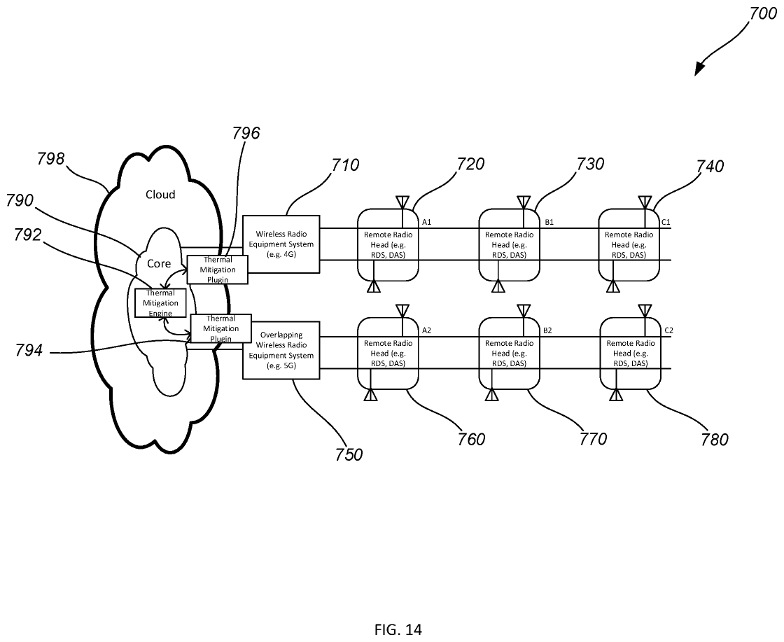

As shown in FIG. 14, a simplified block diagram of an embodiment of an exemplary telecommunications network system 200 in a cloud implementation of the present invention is shown. In this embodiment, the system includes a core network 790 located within a cloud computing environment 798. The core network 790 has a first wireless radio equipment system 710, such as a 4G network, having a plurality of remote radio heads, 720, 730, 740, and having a second wireless radio equipment system 750, such as a 5G network, having a plurality of remote radio heads, 760, 770, 780. The first and second wireless radio equipment systems 710, 750 are also contained, as least partially, within the cloud computing environment 798.

Within the cloud computing environment 798, and connected between the wireless radio equipment systems 710, 750 and the core network 790 are thermal mitigation component 794, 796 that are configured monitor the operating temperature of the associated radio head by reviewing the temperature reports received from each of the remote radio heads, for example through a push or pull procedure, to determine if thermal management is needed to cool a hot radio head, institute system-wide thermal management actions, and provide thermal management instructions to one or more of the associated remote radio heads.

Within the core network 790 is a thermal mitigation component 792. To be effective, the deployment of systematic network reconfiguration for thermal management needs to be collectively management across the entire telecommunications network. Accordingly, the thermal mitigation component 792 is configured to provide thermal management cooperation across both systems 710 and 750.

While the entire method and system has been disclosed as being capable of being realized centrally in a cloud environment, this is illustrative. The various embodiments of the present invention may also be so capable. For example, the embodiments directed toward MIMO puncturing or CA puncturing may be implemented locally at the wireless radio equipment system or centrally at the cloud.

As will be appreciated by one of skill in the art, the concepts described herein may be embodied as a method, data processing system, and/or computer program product. Accordingly, the concepts described herein may take the form of an entirely hardware embodiment, an entirely software embodiment or an embodiment combining software and hardware aspects all generally referred to herein as a “circuit” or “module.” Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object-oriented programming language such as Java® or C++. However, the computer program code for carrying out operations of the disclosure may also be written in conventional procedural programming languages, such as the “C” programming language. Machine learning models can be implemented using for example, R or Python libraries. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or sub-combination.

The following abbreviations are explained:

| Abbreviation | Explanation |
|---|---|
| 3G | Third Generation Wireless Technology, |
| | typically WCDMA and HSPA |
| 4G | Fourth Generation Wireless Technology, |
| | typically LTE |
| 5G | Fifth Generation Wireless Technology, |
| | typically NG |
| DAS | Distributed Antenna System |
| MIMO | Multiple In Multiple Out |
| RAT | Radio Access Technology |
| RDS | Radio Dot System |
| RF | Radio Frequency |
| UE | User Equipment |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method for thermal management of a telecommunications network having a wireless radio equipment system in communication with a plurality of radio heads, each of the plurality of radio heads has a high operating temperature threshold, the method comprises the steps of:
obtaining the operating temperature of the plurality of radio heads;
determining if at least one of the radio heads exceeds its high operating temperature threshold; and
reconfiguring the telecommunications network when the operating temperature of the at least one of the plurality of radio heads exceeds its high operating temperature threshold to reduce the operating temperature of the at least one of the plurality of radio heads.

2. The method of claim 1, wherein the step of monitoring comprises monitoring by periodically polling each of the plurality of radio heads to report temperature.

3. The method of claim 2, wherein the step of monitoring comprises monitoring by periodically pushing of temperature report by each of the plurality of radio heads.

4. The method of claim 3, wherein the step of monitoring comprises monitoring by requesting each of the plurality of radio heads to report any significant event that effects its operating temperature.

5. The method of claim 4, wherein the any significant event is defined as exceeding the high operating temperature threshold.

6. The method of claim 5, wherein the step of reconfiguring the telecommunications network comprises:
reducing power consumption by traffic shaping.

7. The method of claim 6, wherein traffic shaping includes a handoff of an entire user equipment to the same or a different radio head of the plurality of radio heads.

8. The method of claim 7, wherein the step of reconfiguring the telecommunications network comprises:
reducing power consumption by reducing the maximum throughput of the at least one of the plurality of radio heads exceeds its high operating temperature threshold.

9. The method of claim 8, wherein the step of reconfiguring the telecommunications network comprises:
reducing power consumption by reducing power to the at least one hot radio head of the plurality of radio heads and increasing power to the remainder of the plurality of radio heads.

10. The method of claim 9, wherein the step of reconfiguring the telecommunications network comprises:
puncturing of the telecommunications network to reduce heat generated by the radio head.

11. The method of claim, wherein puncturing is defined as MIMO puncturing and the puncturing of the telecommunications network includes turning off at least one antenna branch of the telecommunications network.

12. The method of claim 10, wherein puncturing is defined as CA puncturing and the puncturing of the telecommunications network includes turning off at least one filter branch or carrier of the telecommunications network.

13. The method of claim 12, wherein the step of reconfiguring the telecommunications network comprises:
reducing power consumption by carrier relocation including moving a carrier from a first branch to a second branch and turning off the second branch.

14. The method of claim 13, wherein the step of reconfiguring the telecommunications network comprises:
reducing power consumption by reducing the bandwidth of the transmitting signal.

15. The method of claim 14, wherein the step of reconfiguring the telecommunications network comprises:
reducing power consumption by reducing power across the entire bandwidth.

16. The method of claim 15, wherein at least one of the plurality of radio heads is a remote radio head.

17. The method of claim 16, wherein at least one of the plurality of radio heads is a local radio head.

18. The method of claim 17, wherein the step of reconfiguring the telecommunications network is performed for a predetermined amount of time and stopped upon the expiration of the predetermined amount of time.

19. The method of claim 17, wherein each of the plurality of radio heads has a normal operating temperature range, and wherein the normal operating temperature range for each of the plurality of radio heads is less than its high operating temperature threshold.

20. The method of claim 17, wherein each of the plurality of radio heads has a maximum operating temperature, and wherein the maximum operating temperature for each of the plurality of radio heads is greater than its high operating temperature threshold.

21. The method of claim 19, wherein each of the plurality of radio heads has a maximum operating temperature, and wherein the maximum operating temperature for each of the plurality of radio heads is approximately equal to its high operating temperature threshold.

22. The method of claim 21, wherein the step of reconfiguring the telecommunications network is performed until the operating temperature of the at least one of the plurality of radio heads is reduced below its high operating temperature threshold.

23. The method of claim 21, wherein the step of reconfiguring the telecommunications network is performed until the operating temperature of the at least one of the plurality of radio heads is within its normal operating temperature range.

24. A wireless radio equipment system in communication with a plurality of radio heads, the wireless radio equipment system comprising:
a thermal management component configured to perform any operations of obtaining the operating temperature of the plurality of radio heads;
determining if at least one of the radio heads exceeds its high operating temperature threshold; and
reconfiguring the telecommunications network when the operating temperature of the at least one of the plurality of radio heads exceeds its high operating temperature threshold to reduce the operating temperature of the at least one of the plurality of radio heads.

25. (canceled)

26. (canceled)

27. (canceled)
